(19) United States
(12) Patent Application Publication
(10) Pub. No.: US 2011/0157486 A1
(43) Pub. Date: Jun. 30, 2011

(54) ESCAPE GUIDING APPARATUS AND ESCAPE GUIDING SYSTEM

(75) Inventors: Akihiro MURATA, Hokuto (JP); Osamu KOBAYASHI, Minowa (JP); Hiroaki HOSOMI, Minowa (JP)

(73) Assignee: SEIKO EPSON CORPORATION, Tokyo (JP)

(21) Appl. No.: 12/962,765

(22) Filed: Dec. 8, 2010

(30) Foreign Application Priority Data
Dec. 25, 2009 (JP) 2009-294052

(51) Int. Cl. H04N 9/31; G03B 21/00

(52) U.S. Cl. 348/744; 353/28; 353/11; 348/E09.025

(57) ABSTRACT

An escape guiding apparatus includes: a projecting section projecting an image on a floor by scanning a laser beam; a storage section storing escape guidance information for guiding a person who is escaping; and an image information generating section generating image information of the image to be projected based on the escape guidance information stored in the storage section.

### BACKGROUND

1. Technical Field

The present invention relates to escape guiding apparatuses and escape guiding systems.

2. Related Art

In buildings and vehicles, a direction board guiding the people to the nearest emergency exit and a green-and-white guide light to the emergency exit are placed in order to evacuate the people immediately in the event of an emergency such as a disaster. In addition to the direction board and the guide light to the emergency exit, as an apparatus for guiding the people who are escaping, JP-A-2006-215703 (Patent Document 1), for example, proposes an escape guiding apparatus which places a guide light used at the time of evacuation on the floor or the treads of a stair. Moreover, JP-A-2004-329390 (Patent Document 2) proposes an escape guiding apparatus which projects and displays an image for guiding the people who are escaping by turning a projector.

However, in the escape guiding apparatus described in Patent Document 1, since the display part is directly placed on the floor, the display part is damaged or stained by dust or by being trodden by the shoes. This may impair visibility in an emergency. Moreover, the escape guiding apparatus described in Patent Document 2 has to turn the projector and therefore increases in size. In addition, a time lag etc. caused when the projector is turned delays escape guiding display at the time of disaster.

### SUMMARY

An advantage of some aspects of the invention is to solve at least part of the problems described above, and the invention can be embodied as the following forms or application examples.

### Application Example 1

This application example is directed to an escape guiding apparatus including: a projecting section projecting an image on a floor by scanning a laser beam; a storage section storing escape guidance information for guiding a person who is escaping; and an image information generating section generating image information of the image to be projected based on the escape guidance information stored in the storage section.

According to the escape guiding apparatus described above, based on the escape guidance information stored in the storage section, the image information generating section generates image information. Then, based on the image information, the projecting section projects an image on the floor by scanning the laser beam.

Since the image based on the escape guidance information is projected on the floor, even when, for example, an upper part of the space in a building is filled with smoke when a fire breaks out, the person who is escaping can see the escape guiding information projected on the floor. Moreover, since the apparatus adopts a system in which an image is projected on the floor by scanning the laser beam, the apparatus seldom produces an out-of-focus image which is sometimes produced by a normal projector. Furthermore, since the apparatus uses a laser beam with high color purity, the apparatus can instantly display an image guiding a person who is escaping, the image with higher visibility than that of an image produced by the normal projector. In addition, the apparatus can prevent a problem associated with a display part which is stained with dust or trodden by the shoes. As a result, it is possible to evacuate the person without delay when an emergency such as a disaster occurs.

### Application Example 2

In the escape guiding apparatus described above, the image information generating section may change at least one of the area, the aspect ratio, and the color of the image to be projected with predetermined timing.

According to the escape guiding apparatus described above, by changing at least one of the area, the aspect ratio, and the color of the image to be projected with predetermined timing, it is possible to ensure the visibility of the image guiding the person who is escaping when an emergency such as a disaster occurs.

### Application Example 3

In the escape guiding apparatus described above, the image information generating section may change at least one of the aspect ratio and the color of the image to be projected with predetermined timing without changing the area of the image.

According to the escape guiding apparatus described above, by changing the aspect ratio of the image to be projected with predetermined timing without changing the area of the image, it is possible to ensure the visibility of the image guiding a person who is escaping when an emergency such as a disaster occurs without changing the brightness of the image. This makes it possible to guide the escaping person for longer periods by making effective use of the battery even when power supply is stopped due to a power failure which occurs under emergency conditions.

### Application Example 4

In the escape guiding apparatus described above, the projecting section may change a projection position of the image to be projected to at least one of a wall surface and a ceiling surface with predetermined timing.

According to the escape guiding apparatus described above, by changing the projection position of the image to be projected to at least one of a wall surface and a ceiling surface with predetermined timing, it is possible to ensure the visibility of the image guiding a person who is escaping when an emergency such as a disaster occurs.

### Application Example 5

In the escape guiding apparatus described above, the predetermined timing may be a predetermined time interval.

According to the escape guiding apparatus described above, by changing the image at predetermined time intervals, it is possible to ensure the visibility of the image guiding a person who is escaping when an emergency such as a disaster occurs.

### Application Example 6

In the escape guiding apparatus described above, the projecting section may project an image on the floor along a route via which the person who is escaping is guided.

According to the escape guiding apparatus described above, by projecting the image on the floor along a route via which the person who is escaping is guided, it is possible to guide the escaping person reliably when an emergency such as a disaster occurs.

### Application Example 7

In the escape guiding apparatus described above, the laser beam may be red, blue, and green lights.

According to the escape guiding apparatus described above, it is possible to project a easily-viewable color image on the floor by using the red, blue, and green lights.

### Application Example 8

The escape guiding apparatus described above may further include a moving direction determining section determining a moving direction of the person, and, when the moving direction determining section determines that the person is moving in a direction which is different from a direction in which the escaping person has to be guided, the projecting section may project an image indicating that the person is moving in a wrong direction.

According to the escape guiding apparatus described above, the moving direction determining section determines a moving direction of the person, and, when it is determined that the person is moving in a direction which is different from a direction in which the escaping person has to be guided, an image indicating that the person is moving in a wrong direction is projected. This makes it possible to guide the escaping person reliably when an emergency such as a disaster occurs.

### Application Example 9

The escape guiding apparatus described above may further include a disaster detecting section detecting the occurrence of a disaster, and, when the occurrence of a disaster is detected by the disaster detecting section, the projecting section may project the image on the floor.

According to the escape guiding apparatus described above, when the occurrence of a disaster is detected by the disaster detecting section, the image is projected on the floor. This makes it possible to maintain a normal floor state when no disaster occurs.

### Application Example 10

This application example is directed to an escape guiding system including a server and an escape guiding apparatus which is able to communicate with the server, the escape guiding system in which the escape guiding apparatus includes a receiving section receiving, from the server, evacuation order information for evacuating a person, a projecting section projecting an image on a floor by scanning a laser beam when the receiving section receives the evacuation order information, a storage section storing escape guidance information for guiding the person who is escaping, and an image information generating section generating image information of the image to be projected based on the escape guidance information stored in the storage section.

According to the escape guiding system described above, in the escape guiding apparatus, when the receiving section receives the evacuation order information from the server, the image information generating section generates image information based on the escape guidance information stored in the storage section. Then, based on the image information, the projecting section projects an image on the floor by scanning the laser beam.

Since in the escape guiding apparatus the image based on the escape guidance information is projected on the floor based on the evacuation order information from the server, even when, for example, an upper part of the space in a building is filled with smoke when a fire breaks out, the escaping person can see the escape guiding information projected on the floor. Moreover, since the apparatus adopts a system in which an image is projected on the floor by scanning the laser beam, the apparatus can instantly display an image with high visibility, the image guiding a person who is escaping. In addition, the apparatus can prevent a problem associated with a display part which is stained with dust or trodden by the shoes. As a result, it is possible to evacuate the person without delay when an emergency such as a disaster occurs.

### BRIEF DESCRIPTION OF THE DRAWINGS

The invention will be described with reference to the accompanying drawings, wherein like numbers reference like elements.

FIG. 1 is a block diagram showing a schematic configuration of an escape guiding apparatus.

FIG. 2 is a plan view showing the structure of a horizontal mirror.

FIG. 3 is a sectional view of the horizontal mirror.

FIG. 4 is a plan view showing the structure of a vertical mirror.

FIG. 5 shows an example of an image projected on the floor of a passage.

FIG. 6 is a flow chart showing the operation of an image information generating section of an escape guiding apparatus according to a second embodiment.

FIGS. 7A to 7C show examples in which the image projected on the floor of the passage is changed every time a predetermined time elapses.

FIG. 8 is a block diagram showing a schematic configuration of an escape guiding apparatus according to a third embodiment.

FIG. 9 shows an example of an image projected on the floor of the passage by detecting an error in a moving direction.

FIG. 10 is a block diagram showing a schematic configuration of an escape guiding apparatus according to a fourth embodiment.

### DESCRIPTION OF EXEMPLARY EMBODIMENTS

### First Embodiment

Hereinafter, an escape guiding apparatus according to a first embodiment will be described with reference to the drawings.

### Schematic Configuration of Escape Guiding Apparatus

First, a schematic configuration of an escape guiding apparatus according to this embodiment will be described.

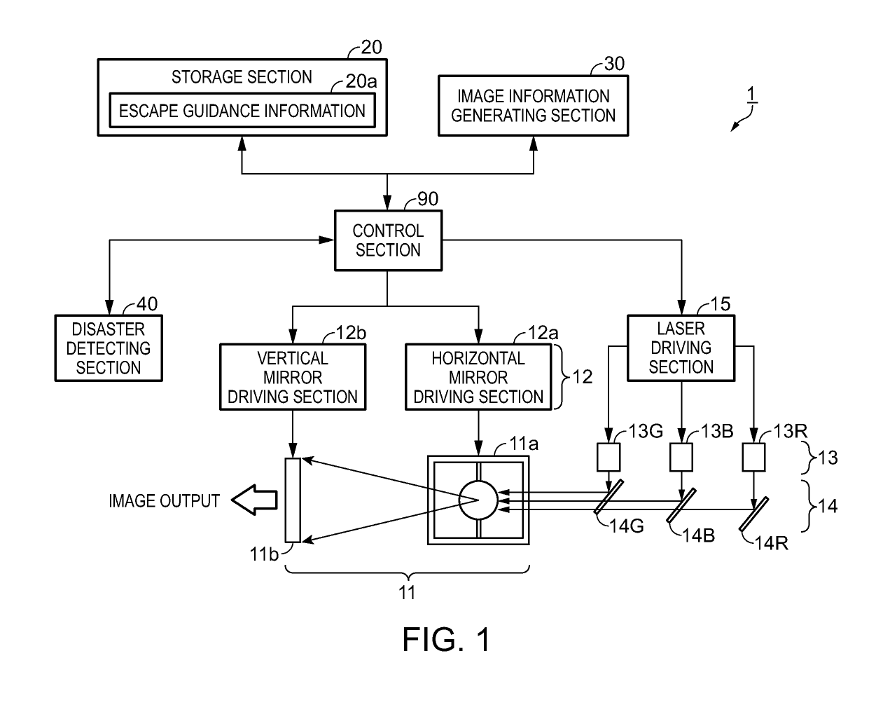

FIG. 1 is a block diagram showing a schematic configuration of an escape guiding apparatus 1 according to this embodiment. As shown in this drawing, the escape guiding apparatus 1 includes a light deflector 11, a driving section 12, a light source 13, a dichroic mirror 14, a laser driving section 15, a storage section 20, an image information generating section 30, a disaster detecting section 40, and a control section 90. Here, the light deflector 11, the driving section 12, the light source 13, the dichroic mirror 14, and the laser driving section 15 are configured as a projecting section projecting an image by scanning a laser beam.

The light deflector 11 includes a horizontal mirror 11a scanning the laser beam sent from the light source 13 in a horizontal direction and a vertical mirror 11b scanning the laser beam reflected by the horizontal mirror 11a in a vertical direction.

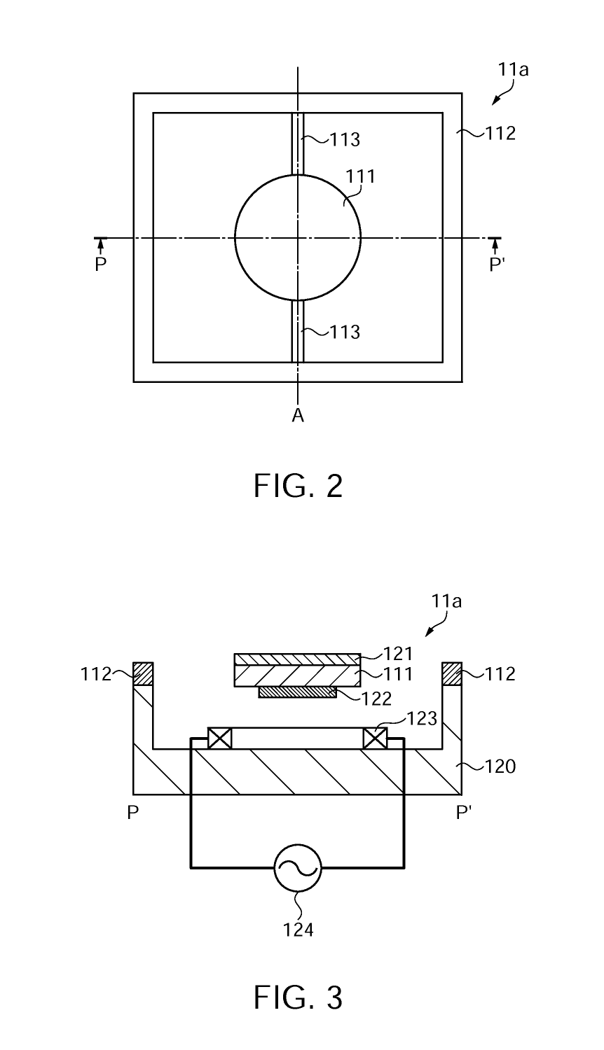

FIG. 2 is a plan view showing the structure of the horizontal mirror 11a, and FIG. 3 is a sectional view taken on the line P-P′ of FIG. 2. The horizontal mirror 11a has a movable plate 111, a supporting frame 112, and a pair of elastic supporting parts 113 which support the movable plate 111 in such a way that the movable plate 111 can torsionally rotate with respect to the supporting frame 112. The movable plate 111, the supporting frame 112, and the elastic supporting parts 113 are integrally formed by performing etching on a silicon substrate, for example.

On the movable plate 111, a reflective film 121 is formed. Moreover, a magnet 122 is bonded to the side of the movable plate 111 opposite from the reflective film 121. The magnet 122 is magnetized in a direction perpendicular to an axis line A which is a central axis of rotation of the movable plate 111 when the movable plate 111 is seen in a plan view. That is, the magnet 122 has a pair of magnetic poles having different polarities and facing each other with the axis line A placed between them. The supporting frame 112 is bonded to a holder 120, and, on the holder 120, a coil 123 for driving the movable plate 111 is placed.

In the horizontal mirror 11a, a voltage or current which changes periodically is supplied to the coil 123 by a drive signal generating section 124. As a result, the coil 123 alternately generates a magnetic field directed upward (directed to the movable plate 111) and a magnetic field directed downward. Then, one magnetic pole of the pair of magnetic poles of the magnet 122 moves closer to the coil 123 and the other magnetic pole moves away from the coil 123, whereby the movable plate 111 is turned around the A axis while torsionally deforming the elastic supporting parts 113.

FIGS. 2 and 3 show a vibrating mirror driven by a drive system using an electromagnetic force between the magnet 122 and the coil 123. However, the invention may adopt a system using an electrostatic attractive force or a system using a piezoelectric element. For example, in the system using an electrostatic attractive force, the magnet 122 is unnecessary, and, instead of the coil 123, one or a plurality of electrodes facing the movable plate 111 are placed. Then, an electrostatic attractive force is exerted between the movable plate 111 and the electrode by applying, between the movable plate 111 and the electrode, an alternating voltage which changes periodically, whereby the movable plate 111 is turned around the A axis while torsionally deforming the elastic supporting parts 113.

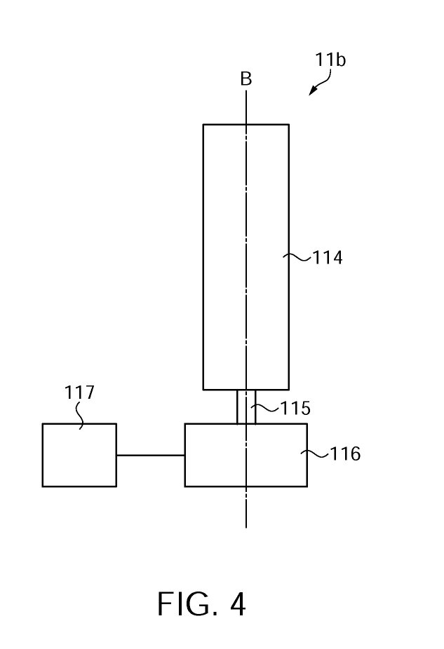

FIG. 4 is a plan view showing the structure of the vertical mirror 11b. The vertical mirror 11b has a movable plate 114, a driving section 116, and a connecting section 115 connecting the movable plate 114 and the driving section 116. On the movable plate 114, an unillustrated reflective film is formed. The connecting section 115 connects the movable plate 114 and the driving section 116 so that the movable plate 114 can turn around the B axis. The driving section 116 may be a step motor, for example. Moreover, the vertical mirror 11b may be formed as a galvano scanner. Furthermore, the vertical mirror 11b may be structured in the same manner as the horizontal mirror 11a.

Back in FIG. 1, the driving section 12 has a horizontal mirror driving section 12a which turns the horizontal mirror 11a and a vertical mirror driving section 12b which turns the vertical mirror 11b. The horizontal mirror driving section 12a has the magnet 122, the coil 123, and the drive signal generating section 124 which are shown in FIG. 3. As described above, the horizontal mirror driving section 12a is so configured as to vibrate (turn) the movable plate 111 with respect to the supporting frame 112 by applying a voltage or current to the coil 123 from the drive signal generating section 124. Moreover, the vertical mirror driving section 12b has the driving section 116 and the drive signal generating section 117 which are shown in FIG. 4, and the drive signal generating section 117 applies an appropriate voltage or current to the driving section 116 to turn the movable plate 114 of the vertical mirror 11b.

The light source 13 is alight source emitting a laser beam. The light source 13 has a laser source 13R emitting a red laser beam, a laser source 13B emitting a blue laser beam, and a laser source 13G emitting a green laser beam. Incidentally, two or less color laser sources or four or more color laser sources may be used.

The dichroic mirror 14 has a dichroic mirror 14R which reflects the red laser beam from the laser source 13R, a dichroic mirror 14B which reflects the blue laser beam and allows the red laser beam to pass therethrough, and a dichroic mirror 14G which reflects the green laser beam and allows the blue laser beam and the red laser beam to pass therethrough. The three dichroic mirrors 14R, 14B, and 14G make the combined light beam of the red laser beam, the blue laser beam, and the green laser beam enter the horizontal mirror 11a.

The laser driving section 15 controls the amounts of current supplied to the laser sources 13R, 13B, and 13G, thereby controlling the intensity and light-emitting time of the laser beam emitted from each laser source.

The storage section 20 is formed of, for example, nonvolatile memory such as EEPROM (electrically erasable programmable read-only memory) or flash memory. The storage section 20 stores escape guidance information 20a for guiding the people who are escaping when an emergency such as a disaster occurs.

The image information generating section 30 generates image information of an image to be projected on the floor of a passage based on the escape guidance information 20a stored in the storage section 20. Here, the image to be projected is an image drawn for guiding the people who are escaping from an installation point of the escape guiding apparatus 1 to the nearest emergency exit, for example.

The disaster detecting section 40 detects the occurrence of a disaster near the escape guiding apparatus 1. For example, the disaster detecting section 40 detects the occurrence of fire by a temperature sensor or a smoke sensor, and detects the occurrence of an earthquake by an earthquake sensor.

The control section 90 includes an unillustrated CPU, ROM, RAM, and the like, and controls the above-described parts and mechanisms.

### Operation of Escape Guiding Apparatus

Next, the operation of the escape guiding apparatus 1 will be described.

In the escape guiding apparatus 1, the disaster detecting section 40 continuously monitors the occurrence of a disaster near the escape guiding apparatus 1.

When the occurrence of a disaster is detected by the disaster detecting section 40, the control section 90 makes the image information generating section 30 generate image information of an image to be projected on the floor based on the escape guidance information stored in the storage section 20.

Then, the control section 90 supplies the image information generated by the image information generating section 30 to the laser driving section 15. Based on the supplied image information, the laser driving section 15 determines the amounts of current to be supplied to the laser sources 13R, 13B, and 13G, and emits the laser beam by driving the laser sources 13R, 13B, and 13G according to the amounts of current thus determined.

Based on the image information generated by the image information generating section 30, the control section 90 draws an image by scanning the laser beam sent from the laser sources 13R, 13B, and 13G via the dichroic mirrors 14R, 14G, and 14B in horizontal and vertical directions by controlling the horizontal mirror driving section 12a and the vertical mirror driving section 12b. As a result, the image guiding the people who are in the building or the like and are escaping therefrom is projected on the floor of the passage.

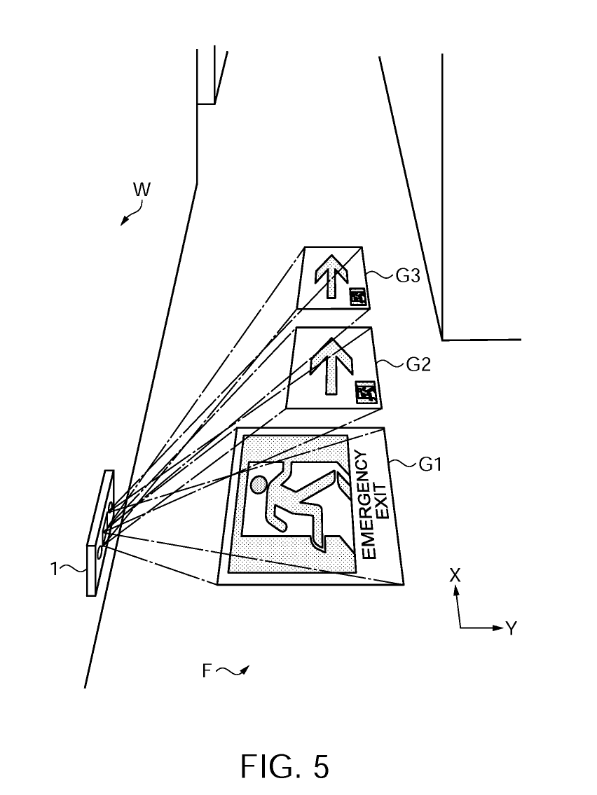

FIG. 5 shows an example of an image projected on the floor of a passage. As shown in this drawing, here, the escape guiding apparatus 1 is placed in a lower portion of a side wall surface W of a passage in a building or the like, and draws three images G1, G2, and G3 on a floor F along the passage.

These images G1, G2, and G3 are drawn along the route via which the escaping people are guided, and are images guiding the escaping people to the nearest emergency exit when an emergency such as a disaster occurs. Moreover, the X direction and the Y direction in FIG. 5 are a horizontal scanning direction and a vertical scanning direction, respectively, in drawing performed by the escape guiding apparatus 1.

In the escape guiding apparatus of this embodiment, the laser beams are emitted from the laser sources 13R, 13B, and 13G of three different colors, and two-dimensional scanning is performed by using the horizontal mirror 11a and the vertical mirror 11b, whereby an image guiding the people who are in the building or the like and are escaping therefrom is projected on the floor of the passage.

Since the image projected in this manner is an image drawn by the laser beam, it is possible to provide visibility even in darkness or smoke when an emergency such as a disaster occurs. Furthermore, since the image drawn by the laser beam has high color purity, it is possible to provide high visibility.

Moreover, since the projection from the escape guiding apparatus is focus free, it is possible to obtain a good image even when, for example, the floor of the passage is a carpeted floor or is a nonflat surface littered with things due to a disaster. In addition, since images can be continuously drawn from a nearby spot to a distant spot, it is possible to guide the escaping people in an understandable way to the emergency exit by drawing a plurality of images along the escape route as the images shown in FIG. 5.

Moreover, since the escape guiding apparatus is placed on a wall surface in a lower portion thereof instead of placing the apparatus directly on the floor and projects an image on the floor, it is possible to prevent damage or stains which the display part gets when the apparatus is placed on the floor. Furthermore, by projecting an image on the floor, it is possible to deal with a problem associated with smoke with which the upper part of the space is often filled when a fire breaks out, the smoke which makes the image less visible.

### Second Embodiment

Hereinafter, an escape guiding apparatus according to a second embodiment will be described.

The escape guiding apparatus according to the second embodiment differs from the escape guiding apparatus according to the first embodiment described above in the function of the image information generating section 30 in the block diagram showing in the schematic configuration shown in FIG. 1. Incidentally, the escape guiding apparatus according to the second embodiment and the escape guiding apparatus according to the first embodiment are the same except for the image information generating section 30.

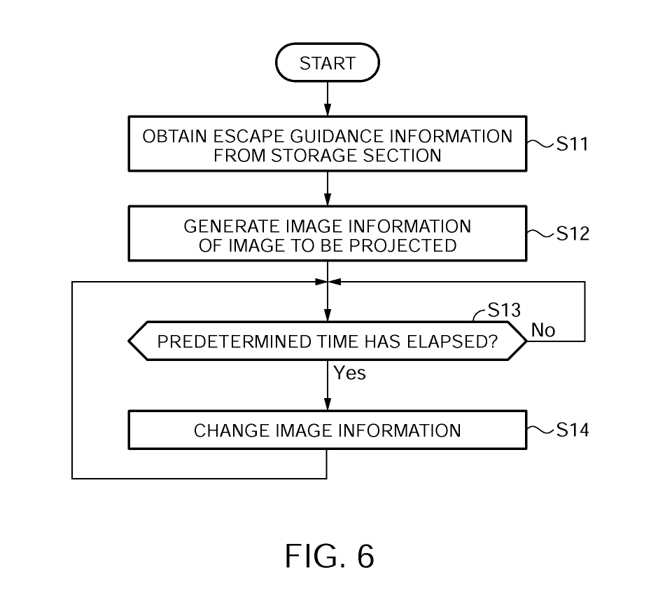

FIG. 6 is a flow chart showing the operation of the image information generating section 30 of the escape guiding apparatus according to the second embodiment. The flow chart of this drawing shows the operation for generating image information of an image to be projected on the floor of the passage based on the escape guidance information 20a obtained from the storage section 20.

First, the image information generating section 30 obtains the escape guidance information 20a stored in the storage section 20 (step S11). Then, the image information generating section 30 generates image information of an image to be projected on the floor of the passage based on the obtained escape guidance information 20a (step S12). Based on the image information generated in this step, the control section 90 projects an image guiding the people who are in the building or the like and are escaping therefrom on the floor of the passage.

While the image is projected on the floor of the passage, the image information generating section 30 determines whether a predetermined time has elapsed or not (step S13). If the predetermined time has not elapsed (step S13: No), the image information generating section 30 waits for until the predetermined time elapses.

On the other hand, if the predetermined time has elapsed (step S13: Yes), the image information generating section 30 changes the image information of the image projected on the floor of the passage (step S14). With this change of the image information, the control section 90 changes the image projected on the floor of the passage to an image based on the changed image information.

Then, the procedure goes back to step S13, and the image information generating section 30 waits for until a next predetermined time elapses.

Incidentally, the length of the predetermined time described above is appropriately set (for example, at intervals of a few seconds) according to the environment in which the escape guiding apparatus is placed.

Here, when the image information is changed in step S14, the area, the aspect ratio, the color, or the like of the image projected on the floor of the passage is changed.

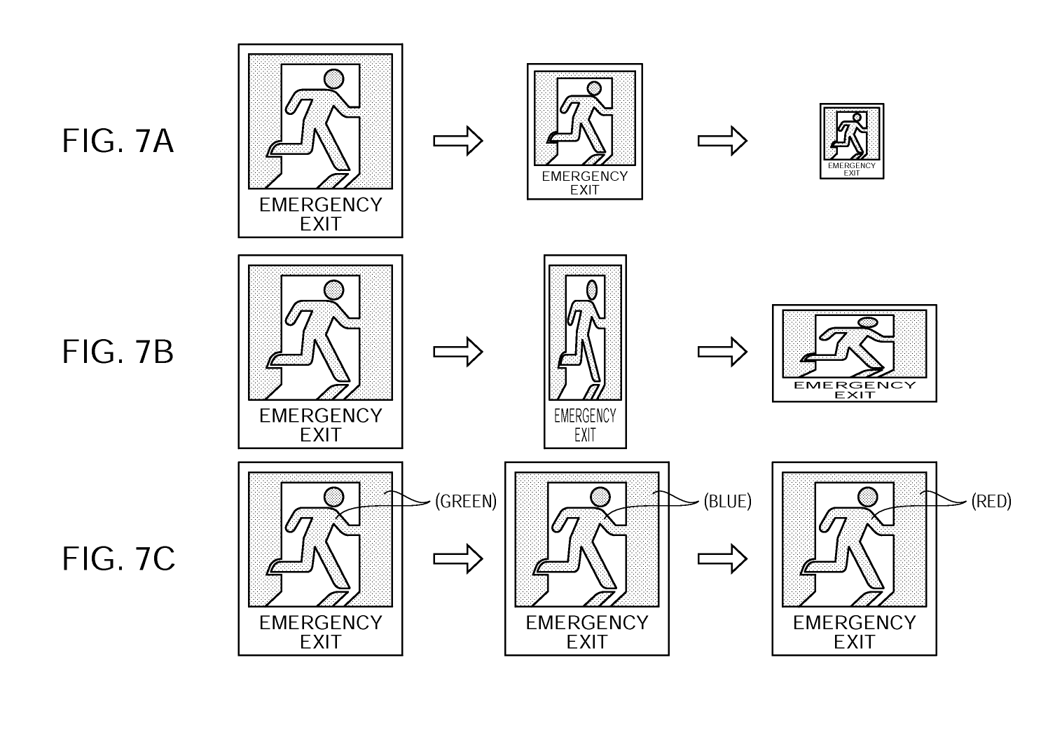

FIGS. 7A to 7C show examples in which the image projected on the floor of the passage is changed every time a predetermined time elapses. Here, examples in which the image G1 in FIG. 5 is changed are shown. FIG. 7A shows an example in which the area of the image region of the projected image is reduced every time a predetermined time elapses, FIG. 7B shows an example in which the aspect ratio of the projected image is changed every time a predetermined time elapses, and FIG. 7C shows an example in which the color of the image is changed every time a predetermined time elapses.

In the escape guiding apparatus of this embodiment, the image to be projected on the floor of the passage is projected while changing the area, the aspect ratio, the color, or the like of the image at predetermined time intervals. For example, by projecting the image while changing the area of the image every time a predetermined time elapses, it is possible to project the reduced, high-intensity image because the area of the drawn image is inversely proportional to the intensity of the image. This makes it possible to ensure the visibility of the image guiding the people who are escaping when an emergency such as a disaster occurs.

Moreover, by projecting the image while changing the aspect ratio of the image every time a predetermined time elapses, it is possible to ensure the visibility of the image guiding the people who are escaping when an emergency such as a disaster occurs irrespective of bumps and dips on the floor.

Furthermore, by projecting the image while changing the color of the image every time a predetermined time elapses, it is possible to ensure the visibility of the image guiding the people who are escaping when an emergency such as a disaster occurs by increasing the degree of color recognition irrespective of the environment such as the color and material of the floor.

Incidentally, the image information of the projected image may be changed by combining the area, the aspect ratio, the color, etc. Moreover, the timing with which the image information is changed is not limited to the predetermined time intervals, and may be the timing determined based on the detection result of a sensor, for example.

### Third Embodiment

Hereinafter, an escape guiding apparatus according to a third embodiment will be described.

The escape guiding apparatus according to the third embodiment differs from the escape guiding apparatus according to the first embodiment in the configuration of the block diagram showing the schematic configuration shown in FIG. 1.

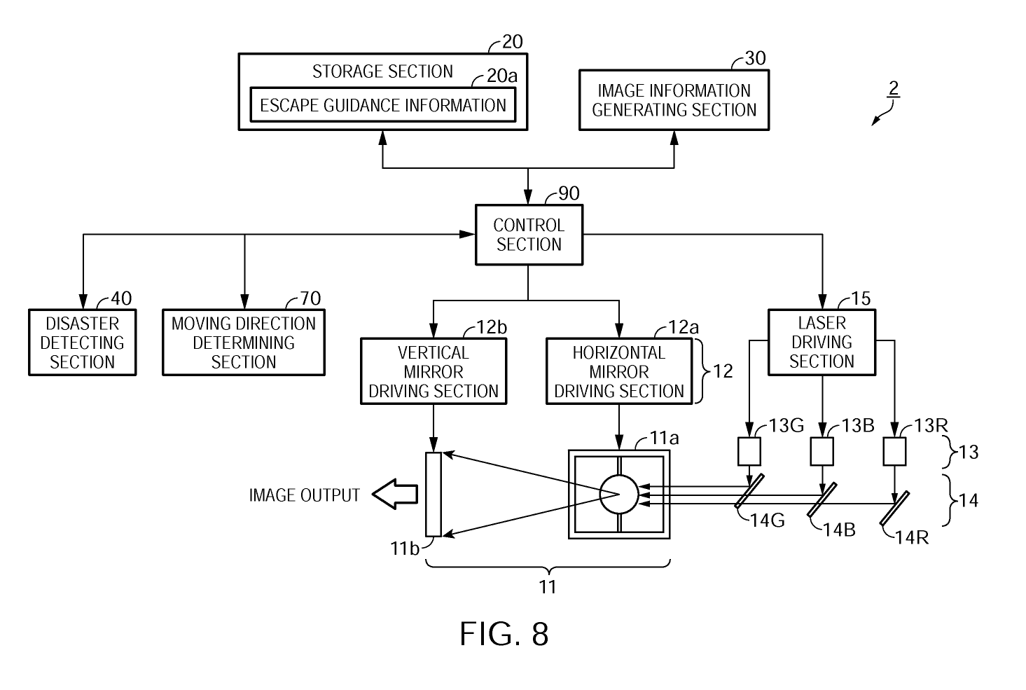

FIG. 8 is a block diagram showing a schematic configuration of an escape guiding apparatus 2 according to the third embodiment. As shown in this drawing, the escape guiding apparatus 2 of this embodiment includes a moving direction determining section 70. Incidentally, the escape guiding apparatus 2 according to the third embodiment and the escape guiding apparatus according to the first embodiment are the same except for the moving direction determining section 70.

The moving direction determining section 70 is provided with a plurality of sensors including an infrared sensor and a human detection sensor which detect the presence of a person, and can determine the direction in which a person is moving when detecting the presence of the person.

When the moving direction determining section 70 detects the presence of a person and determines that the direction in which the person is moving is different from the direction in which the person should be guided, the escape guiding apparatus 2 projects an image indicating that the moving direction is wrong on the floor of the passage. At this time, the image information generating section 30 generates the image information such that the image is projected on a position on the floor in a direction in which the detected person is moving.

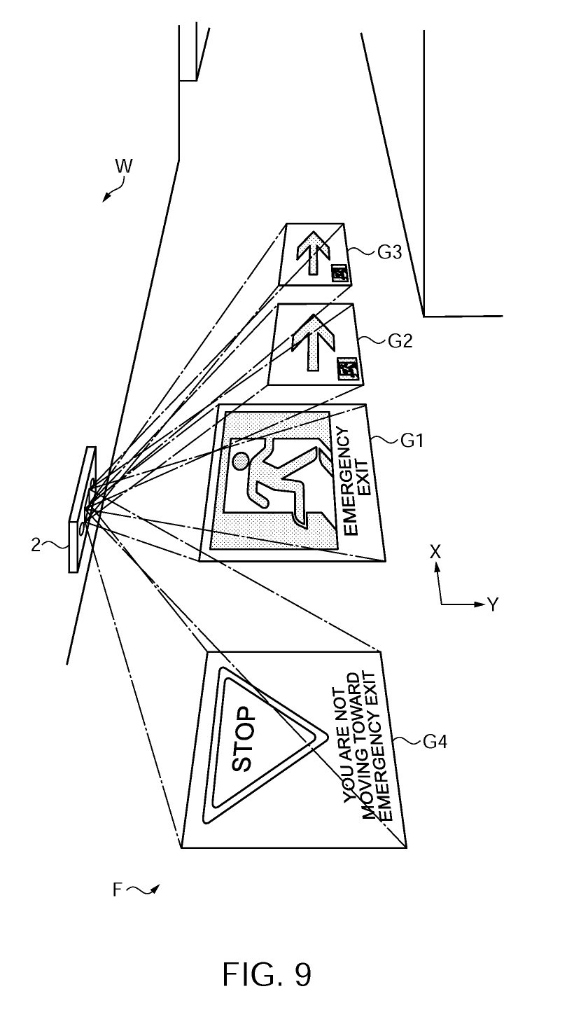

FIG. 9 shows an example of an image projected on the floor of the passage by detecting an error in a moving direction. Here, when a person moves in a direction (a direction opposite to the X direction in the drawing) opposite to the direction (the X direction in the drawing) in which the escaping person should be guided, an image G4 indicating that the person is moving in the wrong direction is projected on the floor F. As described above, in addition to the three images G1, G2, and G3 which are projected along the route via which the escaping person is guided, the escape guiding apparatus 2 projects the image G4 on the floor F in a direction opposite to the direction in which the escaping person should be guided.

In the escape guiding apparatus of this embodiment, when a person moves in a direction opposite to the direction in which the escaping person should be guided, an image indicating that the person is moving in the wrong direction is projected on the floor of the passage in the direction in which the person is moving. As a result, even when an escaping person is about to move in a wrong direction in an emergency such as a disaster, it is possible to guide the person in a correct escape route reliably.

### Fourth Embodiment

Hereinafter, an escape guiding system according to a fourth embodiment will be described.

The escape guiding system according to the fourth embodiment is formed of a server and an escape guiding apparatus connected to the server. Moreover, the escape guiding apparatus according to the fourth embodiment differs from the escape guiding apparatus according to the first embodiment described above in the configuration of the block diagram showing the schematic configuration shown in FIG. 1.

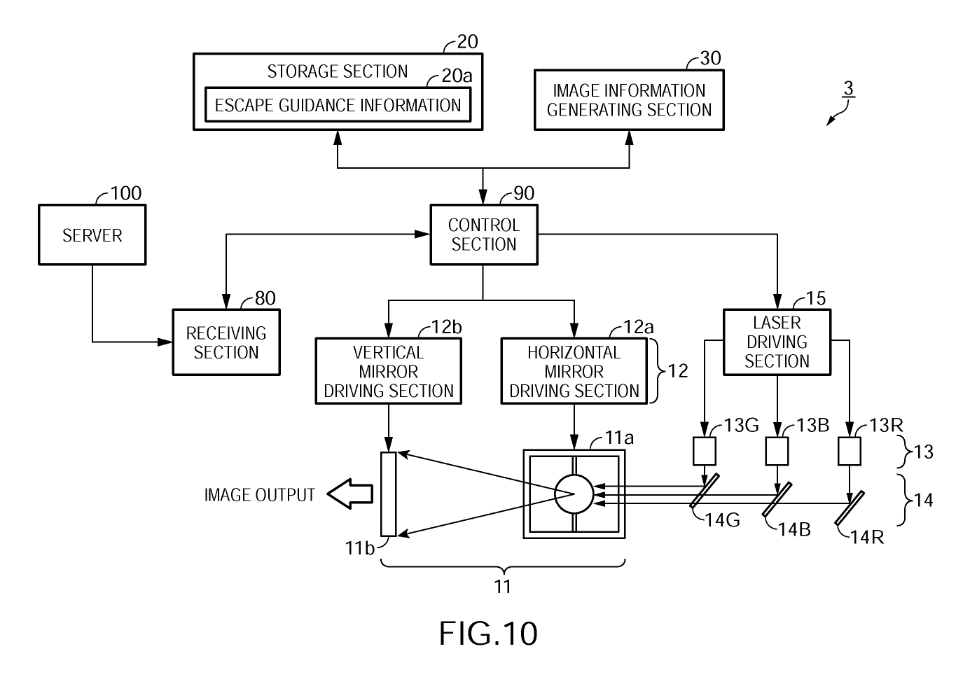

FIG. 10 is a block diagram showing a schematic configuration of an escape guiding apparatus 3 according to the fourth embodiment. As shown in this drawing, the escape guiding apparatus 3 of this embodiment includes a receiving section 80 instead of the disaster detecting section 40 shown in FIG. 1. Moreover, the escape guiding apparatus 3 is connected to a server 100 via a communication line. Incidentally, the escape guiding apparatus 3 according to the fourth embodiment and the escape guiding apparatus according to the first embodiment are the same except for the receiving section 80.

The server 100 incorporates sensors which detect the occurrence of a disaster in the entire area inside a building or the like. When the occurrence of a disaster is detected by the server 100, the server 100 transmits evacuation order information for evacuating the people in the building or the like to the escape guiding apparatus 3 via the communication line. In the escape guiding apparatus 3, the evacuation order information from the server 100 is received by the receiving section 80. Then, based on the evacuation order information, the escape guiding apparatus 3 projects an image guiding the people who are in the building or the like and are escaping therefrom on the floor of the passage.

Incidentally, in the image information generating section 30 of the escape guiding apparatus 3, image information of an image to be projected on the floor of the passage may be generated by adding the evacuation order information received from the server 100 thereto. This makes it possible to project an image on the floor, the image generated according to the latest state of occurrence of the disaster detected by the server 100.

In the escape guiding system of this embodiment, the server detects the occurrence of a disaster in the entire area inside a building or the like. Then, in the escape guiding apparatus which has received the evacuation order information from the server, an image guiding the people who are escaping is projected on the floor of the passage. As a result, the server can grasp the occurrence of a disaster in the entire area inside a building or the like, and issue an escape instruction according to the position in which the escape guiding apparatus is placed and the status thereof. In addition, the escape guiding apparatus can guide the people who are in the building or the like and are escaping therefrom to the escape route according to the status of the disaster in the entire area inside a building or the like.

### Modified Example

In the escape guiding apparatus of the embodiments described above, an image guiding the people who are in the building or the like and are escaping therefrom is projected on the floor of the passage. However, in addition to the floor of the passage, the image may be projected on the wall surface or the ceiling surface of the passage, for example. Moreover, the position in which the image is projected may be moved from the floor to the wall surface, from the wall surface to the ceiling surface, and from the ceiling surface to the floor every time a predetermined time elapses.

As described above, by projecting an image guiding the people who are escaping not only on the floor of the passage but also on the wall surface and the ceiling surface of the passage, the image guiding the people who are escaping is made more visible even when the people's view is limited in a space filled with smoke as a result of fire, for example.

The entire disclosure of Japanese Patent Application No. 2009-294052, filed Dec. 25, 2009 is expressly incorporated by reference herein.

What is claimed is:

1. An escape guiding apparatus comprising:
a projecting section projecting an image on a floor by scanning a laser beam;
a storage section storing escape guidance information for guiding a person who is escaping; and
an image information generating section generating image information of the image to be projected based on the escape guidance information stored in the storage section.

2. The escape guiding apparatus according to claim 1, wherein
the image information generating section changes at least one of the area, the aspect ratio, and the color of the image to be projected with predetermined timing.

3. The escape guiding apparatus according to claim 1, wherein
the image information generating section changes at least one of the aspect ratio and the color of the image to be projected with predetermined timing without changing the area of the image.

4. The escape guiding apparatus according to claim 1, wherein
the projecting section changes a projection position of the image to be projected to at least one of a wall surface and a ceiling surface with predetermined timing.

5. The escape guiding apparatus according to claim 2, wherein
the predetermined timing is a predetermined time interval.

6. The escape guiding apparatus according to claim 1, wherein
the projecting section projects an image on the floor along a route via which the person who is escaping is guided.

7. The escape guiding apparatus according to claim 1, wherein
the laser beam is red, blue, and green lights.

8. The escape guiding apparatus according to claim 1, further comprising:
a moving direction determining section determining a moving direction of the person, wherein
when the moving direction determining section determines that the person is moving in a direction which is different from a direction in which the escaping person has to be guided, the projecting section projects an image indicating that the person is moving in a wrong direction.

9. The escape guiding apparatus according to claim 1, further comprising:
a disaster detecting section detecting the occurrence of a disaster, wherein
when the occurrence of a disaster is detected by the disaster detecting section, the projecting section projects the image on the floor.

10. An escape guiding system comprising:
a server; and
an escape guiding apparatus which is able to communicate with the server, wherein
the escape guiding apparatus includes
a receiving section receiving, from the server, evacuation order information for evacuating a person,
a projecting section projecting an image on a floor by scanning a laser beam when the receiving section receives the evacuation order information,
a storage section storing escape guidance information for guiding the person who is escaping, and
an image information generating section generating image information of the image to be projected based on the escape guidance information stored in the storage section.
